(19) United States
(12) Patent Application Publication
(10) Pub. No.: US 2025/0217943 A1
(43) Pub. Date: Jul. 3, 2025

(54) METHOD FOR CORRECTING IMAGE BLURRING IN A CAPTURED DIGITAL IMAGE

(71) Applicant: Vexcel Imaging GmbH, Graz (AT)

(72) Inventors: Martin Ponticelli, Graz (AT); Stefan Dohr, Knittelfeld (AT); Marc Muick, Hausmannstätten (AT); Christian Neuner, Graz (AT); Michael Gruber, Graz (AT)

(21) Appl. No.: 18/850,914

(22) PCT Filed: Mar. 28, 2023
(86) PCT No.: PCT/EP2023/057903

§ 371 Date: Sep. 25, 2024

(30) Foreign Application Priority Data
Mar. 29, 2022 (AT) A 50203/2022

(51) Int. Cl. G06T 5/73; G06T 7/20

(52) U.S. Cl. CPC G06T 5/73; G06T 7/20; G06T 2207/30241

(57) ABSTRACT

A method for correcting image blurring to make high-quality captured images possible in the event of a relative movement between an object to be captured and a camera, a method for correcting image blurring includes modeling a correlation between an image point in the blurred captured image and an image point of a sharpened captured image with a mathematical model, wherein the model takes into account the relative movement between the camera and the object during the exposure time and contains a density function which describes an influence of the camera on the exposure during the exposure time, and wherein in the mathematical model an image-point-dependent density function is used by means of which a different influence of the camera on the exposure of different image points of the captured image is taken into account during the image correction.

### CROSS REFERENCES

This application is a U.S. National Phase Application of International Application No. PCT/EP2023/057903 filed Mar. 28, 2023, which claims priority to Austrian Application No. A502023/2022 filed Mar. 29, 2022, the disclosures of each of which are hereby incorporated by reference herein in their entirety.

### TECHNICAL FIELD

The present disclosure relates to camera image correction and, more particularly, to a method for correcting image blurring in a captured digital image of an object resulting from relative movement between the camera and the object during an exposure time of the captured image.

### BACKGROUND

When an image is captured with a camera from a moving vehicle, image blurring occurs due to the movement of the vehicle during the exposure time. This is due to the fact that the camera moves relative to the object to be captured during the exposure time, and thus an image point (pixel in the case of a digital image) of the camera is directed at different points of the object during the exposure time. In the case of a commonly used digital camera, an image sensor for each channel (for example, 3 channels in the case of an RGB sensor) is provided with an arrangement of light detectors, where each light detector represents an image point (pixel). Commonly used image sensors are well-known CCD sensors or CMOS sensors. The relative movement between the object to be captured and the camera can be based upon the movement of the vehicle, the movement of the camera relative to the vehicle, the movement of the object, or any combination of these. Such image blurring can be reduced with considerable technical effort during the capture of the image, but cannot be completely avoided.

In order to reduce image blurring, it is known, for example, to move the image sensor of the camera during the exposure time by means of a drive coordinated with a movement of the vehicle (for example, the flight speed of an airplane or other aircraft), so that each pixel of the image sensor remains aligned as precisely as possible with a specific point on the object. This is also known as forward motion compensation. However, this can only compensate for a known forward movement of the vehicle. Other movements and accelerations, in particular pitching, yawing, or rolling of the vehicle, as can occur in aircraft, for example, when flying through turbulence or due to vibrations, cannot be compensated for in this way. Apart from this, forward motion compensation naturally also increases the complexity and cost of the camera system.

To a certain extent, disruptive and unexpected movements of the vehicle can be compensated for by a stabilizing camera suspension, but this also has technical limitations, so that image blurring caused by movement can only be corrected inadequately or not at all. Such a camera suspension also increases the complexity and cost of the camera system.

Recently, image sharpening methods in particular have become widely used. With such image sharpening methods, image blurring in the captured digital image can be subsequently compensated for. This usually involves calculating convolution matrices (often called “blur kernels”), which map the sharp image onto the blurred image using a mathematical convolution operation. This approach is based upon the idea that the blurred captured image and the sharp image hidden within it are connected via the blur kernel. If the blur kernel is known, the sharp image can then be calculated from the blurred image using a mathematical deconvolution operation (the inverse operation of convolution). The fundamental problem here is that the blur kernel is usually not known. In certain approaches, the blur kernel is derived from the blurred image, which is also called blind deconvolution. In other approaches, the blur kernel is ascertained from the known movement of the camera relative to the captured object, which is also called non-blind deconvolution. To detect the movement of the camera, acceleration sensors, gyro sensors, inertial sensors, etc., can be used on the camera. The known movement of the vehicle in a geo-coordinate system and, if applicable, the known movement of the camera relative to the vehicle can be used to infer the relative movement of the camera to the object. In particular, there is a wealth of literature and known methods for ascertaining the blur kernel and for ascertaining the sharp image using the blur kernel, only a few of which are mentioned below.

In the technical article “Image Deblurring using Inertial Measurement Sensors,” Neel Joshi et al., ACM SIGGRAPH 2010 Papers, SIGGRAPH ‘10, New York, NY, USA, 2010, Association for Computing Machinery, the camera movement is first determined using inertial sensors, and, from this, the blur kernel is ascertained, which is used to ascertain the sharp image using deconvolution.

The technical article “Accurate Motion Deblurring using Camera Motion Tracking and Scene Depth,” Hyeoungho Bae et al., 2013 IEEE Workshop on Applications of Computer Vision, discloses the determination of a blur kernel for image sharpening, taking into account camera movement during capture. Furthermore, a depth profile is created based upon a sensor measurement and taken into account when creating convolution matrices for different image areas.

The technical article “Automated Blur Detection and Removal in Airborne Imaging Systems using IMU Data,” C.A. Shah et al., International Archives of the Photogrammetry, Remote Sensing and Spatial Information Sciences, Volume XXXIX-B1, 2012, concerns image sharpening of aerial images. Pitching, yawing, and/or rolling of the aircraft during the capture are measured with an inertial sensor and taken into account when creating the blur kernel.

In “Fast Non-uniform Deblurring using Constrained Camera Pose Subspace,” Zhe Hu et al., Proceedings British Machine Vision Conference 2012, p.136.1-136.11, it is proposed to model the blur kernel as the sum of a temporal sequence of images that are created during the movement of the camera and during the exposure time. The movement of the camera is also estimated from the image content, wherein a set of possible camera poses (position and orientation) is defined, and the influence of these poses on the image blurring is described and weighted with a density function. The movement is determined by calculating the weights of the possible camera poses from this set. This means that the density function, or the weights that the density function describes, are ascertained by image analysis of the captured image. This is similar to a known blind deconvolution. However, this has the disadvantage that very large sets of data have to be processed, which also has a negative impact on the computing time required. Apart from that, the quality of the extracted blur kernel also depends upon the image content. In areas with few prominent structures in the image, this approach may fail because the density function in these areas may not be ascertained at all or may only be ascertained inaccurately.

### SUMMARY

Especially in the field of photogrammetry, the quality requirements for captured images are very high. In such applications, images are often captured using moving vehicles—often aircraft. The above image sharpening methods provide good results, but they are not satisfactory or sufficient for many applications in the field of photogrammetry. This means that the achievable image sharpness is not yet sufficient with the known image sharpening methods—for example, for applications in the field of photogrammetry or geomatics. Another problem with known image sharpening methods is that the position of object structures, such as the outline of a building, can shift in the captured image. This is also highly undesirable in the field of photogrammetry, because in many applications the position and location of object structures play a crucial role.

There is therefore a need for devices and methods that enable images of high-quality i.e., high image sharpness, to be captured with the least possible effort when there is a relative movement between an object to be captured and a camera.

This is achieved by using, in the mathematical model, an image-point-dependent density function by means of which a different influence of the camera on the exposure of different image points of the captured image is mapped.

This makes it possible to map the influence of the camera on the exposure of the image capture, and thus the influence of the camera properties on the image blurring, for each individual image point, or at least for affected image points. This allows the correction of image blurring beyond a previously known extent.

It is particularly advantageous if the discretized image area is divided into a plurality of image sections, and a mathematical model with an image-point-dependent density function is used for the image points of at least one image section and a mathematical model with an image-point-constant density function and constant image trajectory is used for another image section, so that the sharpened captured image can be ascertained for the image points of this image section by a mathematical deconvolution, which requires less computational effort. The sharpened captured image can then easily be assembled from the sharpened captured images of the individual image sections.

In a camera with a mechanical shutter device, the image-point-dependent density function can be used to map an influence of an opening or closing movement of the mechanical shutter device on the exposure of different image points of the captured image. This makes it possible to map the influence of the closing operation of the shutter device, or also the opening operation of the shutter device, on the exposure of the image sensor. This is particularly advantageous because, due to the finite acceleration and speed of the shutter device, the exposure will be different at different image points during the closing or opening process. This influence can be better captured with the image-point-dependent density function, resulting in improved sharpened captured images.

These and other aspects are merely illustrative of the innumerable aspects associated with the present disclosure and should not be deemed as limiting in any manner. These and other aspects, features, and advantages of the present disclosure will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the present disclosure and wherein similar reference characters indicate the same parts throughout the views:

FIG. 1 shows relationships when capturing an image of an object with a moving vehicle,

FIG. 2 shows an idealized shutter movement of a mechanical shutter device, and

FIG. 3 shows an example of a density function of an image point of the captured image.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

In the following detailed description numerous specific details are set forth in order to provide a thorough understanding of the present disclosure. However, it will be understood by those skilled in the art that the present disclosure may be practiced without these specific details. For example, the present disclosure is not limited in scope to the particular type of industry application depicted in the figures. In other instances, well-known methods, procedures, and components have not been described in detail so as not to obscure the present disclosure.

The headings and sub-headings used herein are intended only for general organization of topics within the present disclosure and are not intended to limit the disclosure of the technology or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. All references cited in the “Detailed Description” section of this specification are hereby incorporated by reference in their entirety.

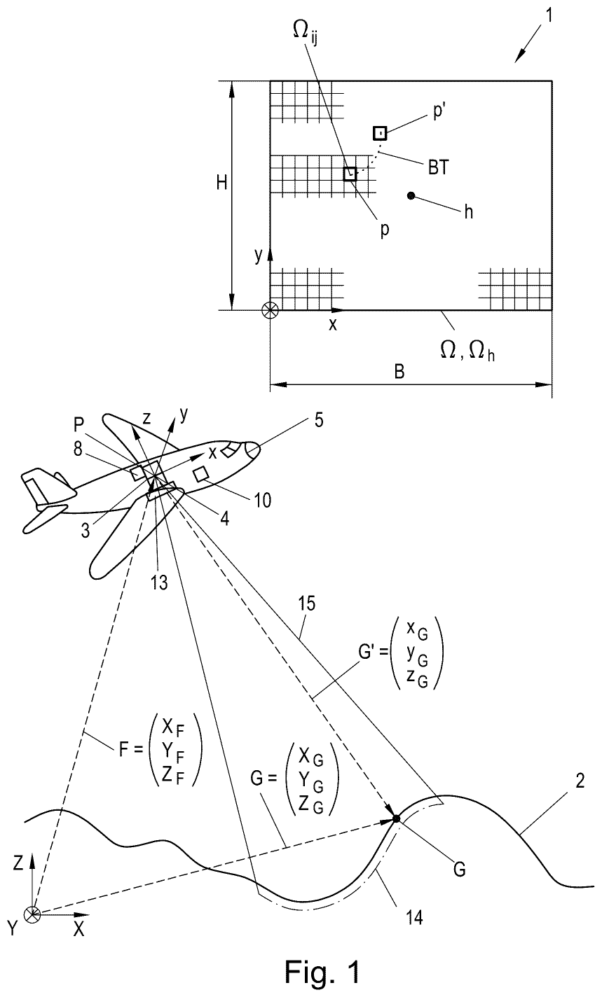

FIG. 1 schematically shows a vehicle 5 (here, an aircraft, e.g., an airplane or a drone) which moves (here, above ground) and creates captured images 1 of an object 2-here, a terrain structure-using a camera 3 mounted on the vehicle 5. FIG. 1 shows, by way of example, a schematic illustration of a captured image 1 taken by the vehicle 5 using the camera 3. The captured image 1 comprises an image area Ω which contains all image points p of the captured image 1. The captured image 1 is a digital captured image, with a width B of pixels and a height H of pixels (digital image points p). The captured image 1 is created on an image plane 4 of the camera 3, on which an image sensor (not shown) is arranged with an array of light detectors that form the image points p.

The present disclosure is presented without restriction of generality for a captured image 1 with one channel (a specific wavelength range of light) of the light spectrum, but can of course be generalized to include multiple channels.

Using geodata, each point of the object 2 (an object point G is shown as an example in FIG. 1) can be assigned a uniquely defined spatial position in a spatially fixed geocoordinate system (X, Y, Z). For example, the position of the object point G in the geocoordinate system can be described by the vector G=(X_{G}, Y_{G}, Z_{G}), and the position of the vehicle 5 (or a reference point of this vehicle 5) can be described in the geocoordinate system by the vector F=(X_{F}, Y_{F}, Z_{F}), wherein the vector F can be related to a predefined vehicle coordinate system.

The camera 3 is assigned a physically fixed camera coordinate system (x, y, z). The coordinate origin of the camera coordinate system (x, y, z) is usually arranged in the optical center of the camera 3, wherein the optical axis of the camera 3 usually coincides with the z-axis of the camera coordinate system. At the distance of the focal length f>0 from the optical center is the image plane 4 of the camera 3, onto which the observed object 2 is mapped two-dimensionally. The image plane 4 is assumed to be parallel to the xy-plane of the camera coordinate system and has its own local 2-D image coordinate system—for example, in a corner of the image area Ω.

The camera 3 with image plane 4 can be fixedly mounted in the vehicle 5, so that a vehicle coordinate system can coincide with the camera coordinate system (x, y, z), and its position with respect to the vehicle coordinate system does not change. If necessary, the camera 3 can also be arranged in a mounting structure that is movable relative to the vehicle 5, e.g., a stabilizing camera suspension, which compensates for movements of the vehicle 5 to a certain extent, such that the orientation of the camera 3 with respect to a direction of travel or flight remains as constant as possible. The camera coordinate system (x, y, z) can therefore also move relative to the vehicle coordinate system. However, the position and orientation of the camera coordinate system (x, y, z) relative to the vehicle coordinate system is always assumed to be known. For example, a suitable motion sensor 8, such as an acceleration sensor, gyro sensor, inertial sensor, etc., can be provided in order to detect the movement of the camera 3 in space relative to the vehicle 5.

The position and orientation of the vehicle 5 in the geocoordinate system (X, Y, Z) can also be assumed to be known on the basis of the known movement data of the vehicle 5 (for example, flight data of an airplane), and the vehicle 5 can execute movements and accelerations in all six degrees of freedom with respect to the geocoordinate system (X, Y, Z). For example, a suitable motion sensor (not shown), such as an acceleration sensor, gyro sensor, inertial sensor, etc., can also be provided on the vehicle 5 in order to detect the movement of the vehicle 5 in space.

These relationships are sufficiently well known. However, the arrangement (position and orientation) and relationships of the coordinate systems with respect to each other can also be different without affecting the present disclosure.

It is known that a point in any coordinate system can be represented as a point in another coordinate system if the relationship between the coordinate systems is known. This allows the position and orientation of the camera coordinate system (x, y, z) or the image coordinate system to be specified in relation to the geocoordinate system (X, Y, Z)—for example, by means of sufficiently well-known coordinate transformations. Using the known coordinate system references, any point in the geocoordinate system (X, Y, Z), e.g., an object point G, can be uniquely mapped to the image plane 4 of the camera 3, e.g., to the image point p in the image area 22, and the image point p can also be specified in the geocoordinate system (X, Y, Z).

The position and orientation of the camera 3 and its field of view 15, which is adjusted using an optical unit 13, determine, in conjunction with the shape of the object 2, a capture area 14, which is indicated schematically in FIG. 1 as a dash-dot line. For the sake of clarity, the object 2 is shown in FIG. 1 as a two-dimensional line. However, it is clear that the capture area 14 is an area that corresponds to a substantially rectangular projection onto the object 2.

The captured image 1 taken by the camera 3 in the illustrated position is shown schematically in FIG. 1, wherein an image point p in the image area Ω can be assigned to an object point G in the capture area 14 due to the optical properties of the camera system. In fact, however, this assignment is not always unique, since the position of the vehicle 5 and/or the camera 3 can continue to move in the direction of movement of the vehicle 5 during the exposure time T required for the capture and/or is subject to other translational and/or rotational movements—for example, due to vibrations, turbulence, etc. In particular, a rotation about one of the axes (which in the context of aircraft is usually referred to as rolling, pitching, and yawing) of the vehicle coordinate system can result in a very significant shift of the capture area 14 on the object 2. The position of the object point G in the captured image 1 (this corresponds to the image point p in FIG. 1 at the beginning of the capture) can shift during the exposure time T (this corresponds to the image point p’ in FIG. 1). In other words, an image point p in the image area Ω can receive light from different object points G during the exposure. This leads to image blurring in the captured image, which is also called motion blurring.

The movement of the object point G in the image area Ω during the exposure time T (between the beginning of the exposure T_{S} and the end of the exposure T_{E}) is shown in FIG. 1 by a dashed line in the form of an image trajectory BT. The image trajectory BT is created by the relative movement between the camera 3 and the object 2 during the exposure time T of the captured image 1, as explained above.

The image trajectory BT of the image point p during the exposure time T can be considered known due to the known relative movement between the camera 3 and the object 2. For this purpose, the known change in the position, orientation, and/or movement (speed, acceleration) of the camera 3 during the exposure time T relative to the object 2 can be evaluated.

The geodata of the object point G can be obtained, for example, from available or proprietary databases. The change in position, orientation, and/or movement of the vehicle 5, such as flight altitude, flight speed, flight direction, etc., during the exposure time T can also be assumed to be known—for example, from corresponding accessible vehicle data.

It is assumed for the present disclosure that the image trajectory BT is known or can be ascertained during the exposure time T, which is always the case due to the relative movement between the camera 3 and object 2 during the exposure time T, which is assumed to be known.

If the relative movement, or the course of the image trajectory BT in the image area Ω, is known precisely, it is possible to create a very effective model for mapping the motion blurring for the corresponding image point p (or for a defined image section of the image area Q consisting of multiple image points p), which takes the actual conditions into account very well. Not only can the translational and rotational movements (speeds and accelerations) of the camera 3 in all directions relative to the geocoordinate system be taken into account, but the blurring that can occur due to the distance of an object point G from the image plane 4, e.g., due to ground elevations such as high-rise buildings, mountains, or the like, can also be taken into account. The model can then be used to ascertain the sharpened image from the blurred captured image 1, as is known from the prior art.

For this purpose, the relationship between an image point p in the blurred captured image 1 and the assigned object point G of the object 2 is modeled using a mathematical model. The model maps the relative movement of the image point p with respect to the object point G, i.e., the image trajectory BT, during the exposure time T. In other words, the model maps from which object points G an image point p in the captured image 1 receives light during the exposure time T, i.e., from which object points G an image point p in the captured image 1 is exposed during the exposure time T. The model also contains a density function ω which describes an influence of the camera on the exposure during the exposure time. The model, expressed as a function f, can thus generally be written in the form

b₍ₚ₎=ƒ(ω,l,H,T,p[η])

The model of the blurred captured image 1 is, of course, obtained from the sum of all individual image points p, wherein each image point b (p) can be modeled using the model.

Here, b (p) describes the blurred image at the image point p, T the exposure time, 1 the sharpened image to be reconstructed, the transformation operator H, which is usually referred to as homography in the technical literature, the movement that the image point p has made during the exposure time T relative to the object 2, which corresponds to the image trajectory BT. Optionally (indicated by the square brackets), noise n that may occur during the exposure at the image sensor 4 can also be taken into account. b (p), for example, describes the total light intensity detected at the image point p during the exposure time T. The light intensity can be understood as the radiant energy that strikes a specific surface perpendicularly in a specific time.

The density function ω describes the influence of the optical system of the camera 3 on the light intensity arriving at the image plane 4 of the camera 3. The density function ω thus changes the light intensity which emanates from the object 2, which represents the object 2 and is detected by the image sensor of the camera 3.

The transformation operator H describes the movement of the camera 3, or the image plane 4 of the camera 3, relative to the object 2 captured by the camera 3, i.e., the relative movement of a camera coordinate system (x, y, z), or image coordinate system (x, y), relative to a geocoordinate system (X, Y, Z). The transformation operator H is thus obtained from the relative movement between the camera 3 and the object 2, and describes the image trajectory BT.

The definition of the transformation operator H is sufficiently well known—for example, from the technical articles mentioned above. The transformation operator H is explained below using an exemplary embodiment.

In this embodiment, the transformation operator H contains the known intrinsic and extrinsic parameters of the camera 3. The intrinsic parameters are at least the focal length f and the position of the principal point h of the camera 3. The principal point h is the intersection point of a normal to the image plane 4 which passes through the optical center of the camera 3, and usually corresponds to the intersection point of the optical axis of the camera 3 with the image plane 4. The coordinates h₀, h₁ of the principal point h in the image coordinate system then describe the position of the principal point h relative to the image coordinate system (x, y)—for example, in a corner of the image plane 4. The extrinsic parameters describe the rotation and translation of the camera 3 and thus the position and orientation of the camera coordinate system, or image coordinate system, relative to the geocoordinate system. However, the extrinsic parameters can also take into account other known influences of the camera on the image, such as distortion, vignetting, or aberration.

The known intrinsic parameters of the camera 3 are summarized, for example, in the matrix

$$C = [ \begin{matrix}f & 0 & {h}_{0} \\ 0 & f & {h}_{1} \\ 0 & 0 & 1\end{matrix} ] .$$

The rotation of the camera 3 is described by a rotation matrix R (t) and the translation by a translation vector S (t), both of which are time-dependent.

The transformation operator H can thus be expressed as follows.

$$H ( t , p ) = P C ( R ( t ) + \frac{1}{d} S ( t ) {n}^{T} ) {C}^{- 1} ( {P}^{T} p + {e}_{2} )$$

The transformation operator H describes the position of the image point p in the image coordinate system at any time t during the exposure, i.e., between the start of exposure T_{S} and the end of exposure T_{E}. The scene depth d is the normal distance of the image point p from the image plane 4 to the object point G and can also be ascertained from the known geodata and movement data of the vehicle 5. The matrix

$$P = ( \begin{matrix}1 & 0 & 0 \\ 0 & 1 & 0\end{matrix} )$$

and the unit vector

$${e}_{2} = ( \begin{matrix}0 \\ 0 \\ 1\end{matrix} )$$

are required for mapping onto the two-dimensional image plane 4. The vector n denotes the unit normal vector, which is directed orthogonally to the image plane 4 of the camera 3.

The orientation of the camera 3, or the camera coordinate system, at time t can be described by the three spatial angles

$${θ}_{t} = ( \begin{matrix}{θ}_{t , X} \\ {θ}_{t , Y} \\ {θ}_{t , Z}\end{matrix} )$$

that describe the relative change with respect to a specific reference coordinate system—for example, in the vehicle coordinate system. The reference coordinate system typically corresponds to the known orientation of the camera 3, or the image plane 4, at a certain time during the exposure, for instance, the orientation at the start time of the exposure T_{S}. Θ then describes the change in orientation with respect to this reference for each time t during the exposure. The rotation matrix R (t) can be expressed by

R(t)=e^{(Θ)}

with

$${Θ}_{t} = ( \begin{matrix}0 & - {θ}_{t , Z} & {θ}_{t , Y} \\ {θ}_{t , Z} & 0 & - {θ}_{t , X} \\ - {θ}_{t , y} & {θ}_{t , X} & 0\end{matrix} ) .$$

The translation vector S (t) describes the position of the camera 3, or the camera coordinate system—also relative to the reference coordinate system.

The transformation operator H thus describes the temporal progression during the exposure time T (between the start time of the exposure T_{S} and the end time of the exposure T_{E}), of the mapping of an object point G in the three-dimensional geocoordinate system onto the two-dimensional image coordinate system (x,y) of the image plane 4. Or, in terms of an image point p, the movement of the image point p during the exposure time T relative to the object 2, i.e., the image trajectory BT.

A known model of the blurred captured image 1 can be written in the form

$$b ( p ) = {\int }_{{T}_{S}}^{{T}_{E}} ω ( τ ) l ( H ( τ , p ) ) d τ [ + η ( p ) ] ,$$

although other mathematical models (other functions f) are of course also conceivable. n denotes noise that is optionally (as indicated by the square brackets) taken into account and that can occur during the exposure on the image sensor 4. The noise is often assumed to be white noise and modeled as a normal distribution or Gaussian distribution.

It can be seen that, in this known model, the density function ω is assumed to be constant in the image plane 4, i.e., it does not change from image point to image point in the image plane 4. The density function ω is therefore an image-point-constant density function.

However, in most cases this does not reflect the real conditions. For example, the shutter of the camera 3, whether mechanical, such as a central shutter, or electronic, such as a rolling shutter (reading out of the pixels in rows or columns) or a global shutter (simultaneous reading out of all pixels at the same time), can produce a different progression of the density function ω in the image. Particularly in the case of mechanical shutter devices, the influence of the shutter movement when opening and/or closing the shutter device can affect the exposure of the individual pixels of the image sensor of the camera 3 during the exposure time T. The mechanical shutter device has a finite opening and/or closing time and a temporal progression of the opening and/or closing movement, such that it takes a certain amount of time for the shutter to actually be fully open and/or closed. This influences the light intensity arriving at the image sensor. However, other devices in the optical unit of the camera, such as a center filter, a color filter, a lens, an aperture, the image sensor itself, etc., can also have an image-point-dependent effect on the density function ω in the image plane 4. Such devices can influence the light intensity of the light arriving at an image point p and/or the light intensity read out by the image sensor.

The influence of the shutter can be easily understood using the example of a mechanical central shutter. The central shutter opens from centrally inside to the outside. During opening, the amount of light reaching the image sensor increases. The temporal progression therefore influences the exposure. During closing, the opposite effect occurs. Such effects will also occur with a curtain shutter or other shutter devices.

Similar effects can be caused by electronic shutter devices, optical filters, the lens, or an aperture. Such components of the optical unit can also influence the density function.

It has been recognized that these effects are image-point-dependent and therefore do not uniformly influence the exposure over the entire image plane 4 or the individual image points p in the image area Ω.

In order to take such influences into account in the reconstruction of the sharp image 1, the density function ω is not modeled as previously only as time-dependent and image-point-constant, but also as image-point-dependent in the image plane 4, according to the present disclosure. The image point dependence refers to the position of an image point p in the image area Ω or to the position of an image section consisting of a plurality of image points p in the image area. The density function ω thus maps an image-point-dependent and time-dependent influence resulting from the configuration of the camera 3 on the exposure of different image points p during the exposure time T.

The above modeling of the blurred image thus changes, for example, to

$$b ( p ) = {\int }_{{T}_{S}}^{{T}_{E}} ω ( p , τ ) l ( H ( τ , p ) ) d τ [ + η ( p ) ] .$$

The density function ω is therefore no longer constant in the image plane 4, but is defined for each image point p in the image plane 4 and is therefore image-point-dependent. T_{S} denotes the start time of the exposure, and T_{E} denotes the end time of the exposure.

However, the density function ω can be image-point-constant for predefined image sections of the image area Ω, wherein an image section is a sub-area of the image area Ω. It is assumed that the density function ω for each image point of such an image section is only time-dependent, but that the density function ω can be different in the individual image sections, which means that the density function ω is also image-point-dependent here.

The aim is now to ascertain the unknown, sharpened image 1 from the model of the blurred captured image 1. To do this, the model is first discretized, because the image sensor consists of a set Ωₕ of discrete pixels.

If the image area Ω of the camera 3 is given by the number H of pixels in the height of the image sensor and the number W of pixels in the width of the image sensor, then the discretized image area Ωₕ can be expressed by the set of pixels

{Ω_{i,j}}_{i=0,j=0}^{H-1,W-1}

with

Ω_{i,j}=[i,i+1]⊗[j,j+1].

The discretized blurred image B and the discretized sharp image L can then be expressed by

B[i,j]=b(p_{i,j})

and

L[i,j]=l(p_{i,j})

where p_{i,j} define the geometric centers of the pixels Ω_{i,j}. In the following, only B and L are used, which describe the entire discrete image, i.e., the set of pixels.

By applying a known numerical integration formula for the model

$$b ( p ) = {\int }_{{T}_{S}}^{{T}_{E}} ω ( p , τ ) l ( H ( τ , p ) ) d τ ,$$

such as the summed midpoint rule or the summed trapezoidal rule, and the above discretizations, a discretized model of the blurred image is obtained, for example, as a linear system of equations

$$B = {\sum }_{k = 0}^{M - 1} {W}_{k} ∘ {H}_{k} L ,$$

where M denotes the number of subintervals of the numerical integration formula for the integration range [T_{S}, T_{E}]. The mathematical operator. is the element-wise multiplication operator.

The transformation operator H maps an image point p in the blurred image B to a specific position in the sharp image 1. However, the change in this position in the sharp image 1 can also be in the subpixel range. A subpixel range is understood to be a resolution within a pixel Ω_{i,j}. This is of course not a problem for the continuous model above, since 1 can be evaluated everywhere. However, as soon as one discretizes into pixels Ω_{i,j}, i.e., uses the discrete images B and L, and wishes to establish the equation for this, it is therefore advantageous if the evaluation in the subpixel range is also possible for the discrete image L. For this purpose, a suitable interpolation, such as bilinear interpolation, can usually be used for discretization in the subpixel range in the discrete image L. In this case, the discrete transformation operator Hₖ is obtained not only from the numerical integration formula, but also contains this discretization of the sharp image L in the subpixel range.

Wₖ and Hₖ are thus the discretized density function and the discretized transformation operator, which result from the application of the numerical integration formula and, if necessary, from a discretization of the sharp image L in the subpixel range (for example, by means of known bilinear interpolation).

With the blur operator

$$A = {\sum }_{k = 0}^{M - 1} {W}_{k} ∘ {H}_{k}$$

the discrete representation for modeling the blur in the image is obtained as a linear system of equations of the form

$$B = AL [ + η ] ,$$

where η again describes the optional noise at the respective pixel.

For such systems of linear equations, with or without noise, there is an abundance of known direct or iterative solution methods that can be applied to ascertain L (i.e., the sharp image). Examples of solution methods are methods based upon the known Richardson-Lucy algorithm or upon known total variation (TV) regularization algorithms.

The Richardson-Lucy method calculates a maximum likelihood estimate based upon an underlying

Poisson distribution as a probability distribution. The resulting iterative method is given by

$${L}^{k + 1} = {L}^{k} ∘ {A}^{T} ( \frac{B}{{AL}^{k}} )$$

where L⁰=B. A^{T} denotes the adjunct blur operator A. The iterative method is carried out until the relative change of successive estimates (generally with index k, k+1) of the sharpened image L falls below a predefined limit ε, which can be mathematically expressed in the form

$$\frac{{‖ {L}^{k + 1} - {L}^{k} ‖}_{2}}{{‖ {L}^{k} ‖}_{2}} < ε ,$$

where ∥ ∥₂ describes the Euclidean norm. L^{k+1} at the time the iteration is terminated then represents the desired sharpened image L.

To reduce the influence of optional (white) noise in the determination of the sharpened image L, a TV regularization can also be incorporated into the method. The iteration rule is then

$${L}^{k + 1} = {L}^{k} ∘ {A}^{T} ( \frac{B}{A {L}^{k}} ) ∘ \frac{1}{1 - λ div ( \frac{∇ {L}^{k}}{\vert ∇ {L}^{k} \vert} )}$$

with a selectable or predefined regularization parameter λ.

In the case of spatially constant motion blurring in the captured image 1, e.g., with negligible camera rotations during the exposure time T, and image-point-constant density function o, the above linear system of equations is reduced to a convolution operation

B=A*L+η

In this case, each image point p describes the same image trajectory BT in the captured image 1. In this case, the blur operator A can be called a blur kernel and describes the constant image blurring, which is different from the pixel-dependent image blurring described above. Such a system of equations can be solved much more efficiently than the above system of equations with spatially varying image blurring.

The iteration rule for the above Richardson-Lucy method is simplified to

$${L}^{k + 1} = {L}^{k} ∘ ( {A}^{T} * ( \frac{B}{A * {L}^{k}} ) ) or {L}^{k + 1} = {L}^{k} ∘ ( {A}^{T} * ( \frac{B}{A * {L}^{k}} ) ) ∘ \frac{1}{1 - λ div ( \frac{∇ {L}^{k}}{\vert ∇ {L}^{k} \vert} )} .$$

This can be exploited according to the present disclosure by assuming constant (in the sense of uniform) motion blurring and image-point-constant density function ω in certain image sections of the captured image 1. The image area Ωₕ is divided into overlapping or non-overlapping image sections Ω_{d}, where Ω_{d}⊂Ωᵣ for d=0, . . . , N_{D}−1. This results for the entire image ND in linear, local systems of equations of the form

B^{d}=K^{d}*I^{d}+η^{d}

or

B^{d}=A^{d}L^{d}+η^{d},

which can be combined into a linear system of equations or solved individually. After solving the local systems of equations, the overall solution L can be calculated from L^{d}, d=0, . . . , N_{D}−1. In the case of overlapping image sections Ω_{d}, a more uniform transition between the individual image sections Ω_{d} can be achieved by suitable blending.

Since the image-point-dependent density function ω(p,t) is derived from the configuration of the camera 3, in particular from the configuration of the shutter device, but also from other optical units of the camera 3, it can be assumed to be known for a specific camera 3.

The advantage of the procedure according to the present disclosure described above for determining the sharpened image L thus also lies in the fact that the image-point-dependent density function ω(p,t) is known and therefore does not have to be ascertained first in the course of ascertaining the sharpened image L—for example, from image data.

The method for image correction is carried out on a computing unit (not shown)—for example, a computer, microprocessor-based hardware, etc. In this case, the method is implemented in the form of program instructions (such as a computer program) that are executed on the computing unit.

The computing unit also receives necessary information, such as data on the movement of the vehicle 5 and/or the camera 3 during the exposure. However, the method could also be implemented on an integrated circuit, such as a field programmable gate array (FPGA) or an application-specific integrated circuit (ASIC), as a computing unit.

To correct the motion blurring in an image taken with a camera 3, wherein a relative movement takes place between the camera 3 and the object 2 being captured during the exposure, the computing unit receives data on the relative movement during the exposure, e.g., movement data from a vehicle 5 in the geocoordinate system and/or data on the movement of a camera 3 relative to a vehicle coordinate system—for example, from a movement sensor 8. With these data on the relative movement and the density function ω(p,t) known for the camera 3, a linear system of equations, or multiple linear, local systems of equations, can be ascertained as described above, from which the sharpened image can be ascertained as described above. Image correction is preferably carried out offline, i.e., after an image has been captured, but it can also be carried out online, immediately after the image has been captured.

The following describes one possible way of determining the image-point-dependent density function ω(p,t). The density function ω(p,t) is also preferably determined on a computing unit. The density function (p,t) can be determined in advance for a specific camera and then stored in a suitable manner for image correction.

To determine the density function o, it is assumed that there is no relative movement between the camera 3 and object 2 during the exposure—for example, by mounting the camera 3 on a rigid test setup and fixedly pointing said camera at an object 2 to be captured. For this purpose, the camera 3 is directed at an object 2 that is as homogeneously bright as possible, such that under ideal conditions the same light intensity should arrive at each image point p during the exposure.

In this example, a camera 3 with a mechanical shutter device behind the aperture of camera 3 is used. In this exemplary embodiment, the camera 3 has electronic exposure control, i.e., the point in time and the time period during which the light detectors of the image sensor are active can be controlled electronically. This makes it possible to make the exposure time T independent of the time limitations of the mechanical shutter device. In particular, this means that substantially shorter exposure times T are possible than would be possible with a mechanical shutter device alone. This also makes it possible to open the shutter device before capturing an image and to control the actual exposure using the electronic exposure control. This makes the captured image independent of the opening of the shutter device. For example, the exposure time T could thus be limited to a part of the closing movement of the shutter device.

The image-point-dependent density function ω(p,t) is intended to map the opening or closing movement of the mechanical shutter device, e.g., a central shutter such as an iris diaphragm, and thus its influence on the exposure. The position dependence can be the result of an opening and/or closing movement of the shutter device that is not completely symmetrical. This effect can also depend upon a set aperture, so that the position dependence can also depend upon other camera parameters, such as the set aperture. To determine the density function ω(p,t), measurements are taken of the amount of light incident on the image sensor of the camera 3 at different exposure settings.

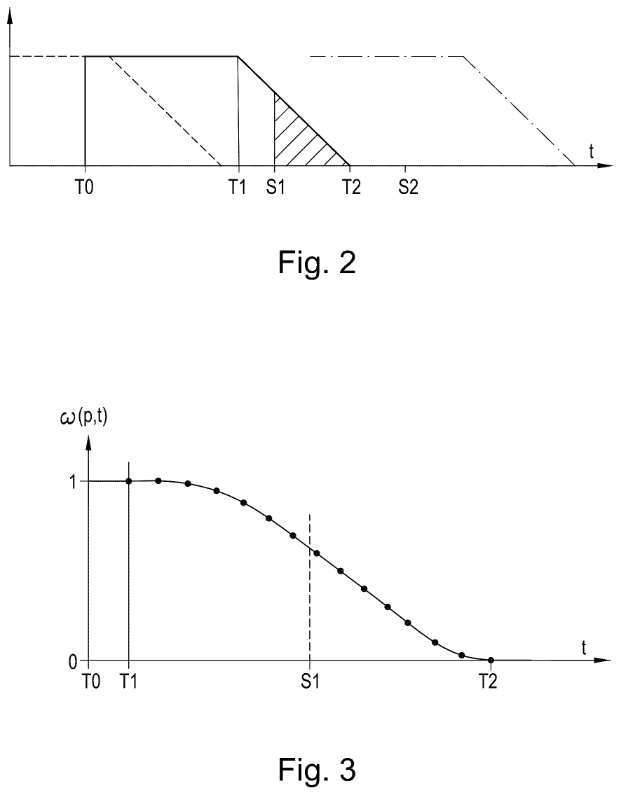

This is explained by way of example with reference to FIG. 2, which shows an idealized shutter movement of a mechanical shutter device. The time T0 is the start of the closing time, i.e., the time of the closing command to close the shutter device. T1 is the known mechanical closing delay time, and (T1−T0) is thus the time period between the closing start time and the time at which the shutter movement begins. The time T2 is the time at which the shutter device is completely closed. The times TO, T1, T2 are fixed and known parameters of the shutter device, but they can vary within normal tolerances. Aging effects can also influence these times. S1 denotes the start of exposure at the image sensor and S2 the end of exposure at the image sensor, which can be set on the camera 3, for example, using the electronic exposure control. The shaded area represents the actual exposure at the image sensor and thus defines the amount of light that reaches the image sensor during the exposure time T. It is assumed that the shutter device is fully open before the time T0.

If the exposure time T is now varied in a series of captures, e.g., by varying the time T0, from a time at which the shutter device is closed before the start of exposure S1 at the image sensor 4 (indicated by dashed lines in FIG. 2) and a time at which the shutter device is fully open during the exposure (indicated by dash-dotted lines in FIG. 2), a progression of the amount of light arriving at the image sensor, specifically at the image points p of the image sensor, is obtained as a function of the actual exposure time T, which can be expressed by (T2−S1), wherein the exposure time can vary between 0 and (S2-S1). Depending upon the aperture, the effective exposure time can be further reduced—for example, if the aperture opening is smaller than the shutter opening. The variation of the exposure can of course also be carried out by leaving the time T0 (and thus also T1, T2) unchanged and varying the start of exposure S1 while keeping the time duration (S2−S1) the same.

To obtain a model of the shutter movement of the shutter device from this series of captures, the following procedure can be used.

Since there is no relative movement between the camera 3 and object 2, the above transformation operator H is reduced to the identity mapping, and the result is

H(t,p)=P

with

P∈Ω.

The above model of the blurred image can thus be rewritten as

$$b ( p , t ) = l ( p ) {\int }_{t}^{{T}_{E}} ω ( p , τ ) d τ ,$$

where a new time variable t is introduced which defines the start of exposure S1 (start time T_{S} of the exposure). b (p,t) describes the image captured—in this case the homogeneous bright area as object 2. As already mentioned, it is assumed that the start of exposure S1 is varied electronically. The partial derivative of this model with respect to t then yields

ω(p,t)=−∂,b(p,t)(l(p))⁻¹.

Based upon this representation of the density function ω(p,t), an approximation can be determined using a series of captures {b(p,tᵢ)}ᵢ₌₀^{Ni-1} consisting of Nt individual captured images with different start times T_{S} of the exposure {tᵢ}ᵢ₌₀^{Nt-1}.

By evaluating

ω(p,t)=−∂b(p,t)(l(p))⁻¹,

e.g., with forward, backward, or central difference quotients, a finite number of observations {(tᵢ,ωᵢ^{p})}ᵢ₌₀^{Ni-1} are obtained at a specific image point p, which describe the temporal progression of the density function ω(p,t) at this image point p. These observations can be stored as a density function ω(p,t), and interpolation can be performed between the times of the observations. The observations {t,ωᵢ^{p})}ᵢ₌₀^{Ni-1} are shown by way of example as points in FIG. 3.

However, based upon the observations {(tᵢ,ωᵢ^{p})}ᵢ₌₀^{Ni-1} and a known curve approximation, a mathematical function can also be ascertained that describes the observations as accurately as possible. This means that the density function ω(p,t) for the image point p can also be stored as a mathematical function depending upon time. This can be done for each image point p. A curve approximating the observations is also shown in FIG. 3. The curve obtained gives a value for the density function ω(p,t) at each time t.

Such curve approximations are sufficiently well known and are usually solved by optimization. For this purpose, a mathematical function ω_{α}_{ₚ}(p,t) with function parameter αₚ is chosen, which can be any function—for example, a polynomial of a certain degree or a polynomial of a certain degree that is defined piecewise and has polynomial coefficients as function parameter αₚ. The function parameters αₚ can be determined, for example, from a known minimization problem that can generally be written in the form

$${α}_{p} := {arg min}_{{α}_{p}} {\sum }_{i = 0}^{{N}_{t} - 1} ρ ( {β}_{i} ( {ω}_{{α}_{p}} ( p , {t}_{i} ) - {ω}_{i}^{p} ) ) + γ ( {α}_{p} ) .$$

Here, βᵢ denotes optional, predefined, or selectable weights, γ an optional, predefined, or selected regularization term for directing the function parameters αₚ in a certain direction if required, and ρ an arbitrary vector norm, such as a Euclidean norm or sum norm. For such minimization problems, there are sufficiently well-known iterative solution algorithms that define how the desired function parameters αₚ are varied in each iteration step and when the iteration is terminated. Known solution algorithms include the gradient method and the Gauss-Newton method.

If the optimization is applied only to one image point p, this is also referred to as local optimization.

This is described below using the example of a polynomial of nth degree as a mathematical function

$${ω}_{{α}_{p}} ( p , t ) , {ω}_{{α}_{p}} ( p , t ) = {\sum }_{j = 0}^{n} {α}_{p , j} {t}^{j} .$$

If the Euclidean norm, the weights βᵢ=1 and γ=0 are chosen, then the regression model

$${α}_{p} := {arg max}_{{α}_{p}} {\sum }_{i = 0}^{{N}_{t} - 1} {‖ ( {ω}_{{α}_{p}} ( p , {t}_{i} ) - {ω}_{i}^{p} ) ‖}_{2}^{2}$$

for determining the parameters αₚ is obtained. The solution to this optimization problem can be stated directly and is given by

$${α}_{p} = {( {G}^{T} G )}^{- 1} {G}^{T} {ω}^{p} with$$

$${α}_{p} = ( \begin{matrix}{α}_{0} \\ {α}_{1} \\ ⋮ \\ {α}_{n}\end{matrix} ) , {ω}^{p} = ( \begin{matrix}{ω}_{0}^{p} \\ {ω}_{1}^{p} \\ ⋮ \\ {ω}_{{N}_{t} - 1}^{p}\end{matrix} ) , G = ( \begin{matrix}1 & {t}_{0} & {t}_{0}^{2} & … & {t}_{0}^{n} \\ 1 & {t}_{1} & {t}_{1}^{2} & … & {t}_{1}^{n} \\ ⋮ & ⋮ & ⋮ & ⋱ & ⋮ \\ 1 & {t}_{{N}_{t} - 1} & {t}_{{N}_{t} - 1}^{2} & … & {t}_{{N}_{t} - 1}^{n}\end{matrix} ) .$$

A mathematical function ω_{α}_{ₚ}(p,t) can be ascertained for each image point p, wherein the function parameters αₚ will differ for different image points p. However, it is not necessary for the mathematical function ω_{α}_{ₚ}(p,t) to be different for each image point p. A mathematical function ω_{α}_{ₚ}(p,t) can also be determined for a number of image points p, wherein, in-between, i.e., for other image points p, interpolation can be performed.

The set of functions ω_{α}_{ₚ}(p,t) ascertained in this way can be used as an approximation for the global density function ω(p,t) for suitably chosen image points p.

It is also conceivable that the number Nₜ of observations be created for a number Nₚ of different image points p in the image area Ω. Then, from these observations, a global model for the density function ω(p,t) for the entire image area Ω could also be created, because it can be assumed that the density function ω(p,t) will normally change only slowly in the image area. The approximated density function ω_{α}_{ₚ}(p,t) would then be a three-dimensional function defined for each image point p and time t. This is also referred to as global optimization.

The optimization problem for a global optimization can be generally written with global function parameters a in the form

$$α := {arg min}_{α} {\sum }_{j = 0}^{{N}_{p} - 1} {\sum }_{i = 0}^{{N}_{t} - 1} ρ ( {β}_{ji} ( {ω}_{α} ( {p}_{j} , {t}_{i} ) - {ω}_{ji} ) ) + γ ( α ) ,$$

which can be solved using suitable methods.

The density function ω(p,t) is preferably normalized to the range [0,1].

The density function ω(p,t) thus ascertained maps the influence of the closing process of the shutter device on the exposure of the image sensor 4.

However, depending upon the configuration of the camera 3 when ascertaining the density function ω(p,t), other influences of the optical system of the camera 3, such as the influence of an aperture, a filter, etc., are also taken into account. For example, the density function ω(p,t) can be ascertained in this way for different aperture settings.

If the exposure is controlled by the shutter movement, then the density function ω(p,t) can be used as ascertained. If electronic exposure control is used, the part of the density function ω(p,t) that is relevant for the exposure process, i.e., the part between T2 and S1, can be used based upon the start time S1 of the exposure (indicated in FIG. 3), which can be related to the time T0 or T1.

In this way, the opening movement of the shutter device can also be modeled. This means that the influence of the opening movement on the exposure of the image sensor 4 can also be mapped as required. However, with electronic exposure control, the opening movement will usually have no influence on the exposure.

The shutter device may also be subject to influences such as environmental influences (pressure, temperature, etc.), aging influences, random fluctuations in the shutter mechanism, etc. It is therefore possible that the density function calibrated in the laboratory environment ω(p,t) does not accurately map the actual conditions in real operation. To ascertain these deviations from the ascertained density function ω(p,t) and, if necessary, to correct them, the following procedure can be followed.

Using a known image analysis of an image captured with the camera 3, the motion blurring occurring in the image can be measured and used to derive adapted values for the function parameters α of a global model for the density function ω(p,t) For this purpose, suitable areas with distinctive structures or characteristic shapes can be searched for in the captured image, typically using gradient-based methods for edge detection, and the blur kernels can be calculated using known methods. One option is the use of so-called blind deconvolution. The blur kernels ascertained from the image data are then used as a basis for optimizing the function parameters α of the global model for the density function ω(p,t)

Cameras 3, particularly for photogrammetry or geomatics applications, often monitor the shutter movement of a shutter device to detect malfunctions. Shutter monitoring units provided for this purpose provide feedback on the movement of the shutter device. One exemplary embodiment of a shutter monitoring unit is in the form of a constant light source, e.g., an LED, and a light sensor that detects the light from the light source. The shutter device is arranged between the light source and the light sensor, such that the light sensor does not detect light from the light source when the shutter device is closed and detects light from the light source when the shutter device is being opened or closed, depending upon the movement of the shutter device. Of course, the shutter monitoring unit must be designed in such a way that the light from the light source does not influence the actual captured image, or the object light from the object being captured is not detected by the light sensor of the shutter monitoring unit. Although the light intensity detected by the light sensor cannot be directly assigned to an image point p of the captured image, it can still be used to obtain feedback on the state of the shutter device.

The light intensity detected by the light sensor will have a certain temporal progression over the shutter movement. Certain information can be obtained from this temporal progression. For example, the beginning of the opening or closing of the shutter device or the complete closing of the shutter device can be detected. Likewise, specific times during the shutter movement could be detected—for example, the time at 20% and 75% of the shutter movement. This could be used to derive a slope of the shutter movement, which allows a statement to be made about the speed of the shutter device. By observing the shutter movement with the light sensor over a plurality of shutter operations, conclusions can be drawn about the state of the shutter device or influences on the shutter device. Of course, this requires an initially calibrated shutter movement as a reference. If, for example, there is an offset in time between the times of the start of opening or closing or the end of opening or closing over the period of use of the shutter device, it is possible to conclude that there is an aging influence or environmental influence. Such an offset can then also, for example, be taken into account in the density function ω(p,t) in order to adapt the density function ω(p,t) to the current conditions. A changing slope of the shutter movement can also be used to adapt the shape of the curve of the density function ω(p,t) accordingly.

The preferred embodiments of the disclosure have been described above to explain the principles of the present disclosure and its practical application to thereby enable others skilled in the art to utilize the present disclosure. However, as various modifications could be made in the constructions and methods herein described and illustrated without departing from the scope of the present disclosure, it is intended that all matter contained in the foregoing description or shown in the accompanying drawings, including all materials expressly incorporated by reference herein, shall be interpreted as illustrative rather than limiting. Thus, the breadth and scope of the present disclosure should not be limited by the above-described exemplary embodiment but should be defined only in accordance with the following claims appended hereto and their equivalents.

1. A method for correcting image blurring in a captured digital image of an object, wherein the captured image is captured with an image sensor of a camera, and, due to a relative movement between the camera and the object during an exposure time T of the captured image, the mapping of an object point (G) of the object onto an image point (p) in the captured image b (p) changes, such that the mapping of the object point (G) in the captured image moves along an image trajectory (BT) during the exposure time T between an exposure start time T_{S} and an exposure end time T_{E}, and thereby image blurring arises in the captured image, wherein a relationship between an image point (p) in the blurred captured image b (p) and an image point (p) of a sharpened captured image l(p) is modeled using a mathematical model
b(p)=ƒ(ω,l,H,T,p[,η]),
wherein the model takes into account the relative movement between the camera and the object during the exposure time T by means of a transformation operator H and contains a density function w which describes an influence of the camera on the exposure during the exposure time T, and n optionally describes noise occurring on the image sensor during the exposure, and wherein, for image correction, a sharpened image l(p) at the image point (p) is ascertained from the blurred captured image b(p) at the image point (p) and the model, characterized in that, in the mathematical model, an image-point-dependent density function ω(p,t) is used by means of which a different influence of the camera on the exposure of different image points (p) of the captured image is taken into account during the image correction.

2. The method according to claim 1, wherein the mathematical model is used in the form
$$b ( p ) = {\int }_{{T}_{S}}^{{T}_{E}} ω ( p , τ ) l ( H ( τ , p ) ) d τ [ + η ( p ) ] ,$$
where η(p) optionally describes a noise at the image point (p).

3. The method according to claim 1, wherein the blurred captured image
B[i,j]=b(P_{i,j})
and the sharpened captured image
L[i,j]=l(p_{i,j})
are discretized into a set of pixels
{Ω_{i,j}}_{i=0,j=0}^{H-1,W-1}
with
Ω_{i,j}=[i,i+1]⊗[j,j+1]
of a discrete image area Ωₕ, with the number H of pixels in the height and the number W of pixels in the width of the image sensor, where p_{i,j} indicates the geometric centers of the pixels Ω_{i,j}.

4. The method according to claim 3, wherein the mathematical model is discretized by applying a numerical integration formula, whereby the mathematical model is converted into a linear system of equations
$$B = {\underbrace{{\sum }_{k = 0}^{M - 1} {W}_{k} ∘ {H}_{k}}}_{A} L [ + η ] ,$$
where M denotes the number of subintervals of the numerical integration formula for the integration range [T_{S}, T_{E}] and Wₖ denotes the discretized density function resulting from the integration formula and Hₖ denotes the discretized transformation operator resulting from the integration formula and where B denotes the discretized blurred captured image and L denotes the discretized sharpened captured image.

5. The method according to claim 4, wherein the discretized sharpened captured image L is discretized in a subpixel range.

6. The method according to claim 4, wherein the linear system of equations is solved to obtain the sharpened captured image L.

7. The method according to claim 6, wherein the linear system of equations is solved using an iterative method with an iteration rule
$${L}^{k + 1} = {L}^{k} ∘ {A}^{T} ( \frac{B}{{AL}^{k}} ) or {L}^{k + 1} = {L}^{k} ∘ {A}^{T} ( \frac{B}{{AL}^{k}} ) ∘ \frac{1}{1 - λ div ( \frac{∇ {L}^{k}}{\vert ∇ {L}^{k} \vert} )}$$
with
L⁰=B
and a predefined termination criterion for the iteration, where 2 is a predefined regularization parameter.

8. The method according to claim 6, wherein an iteration is carried out until the relative change of successive estimates k, k+1 of the sharpened captured image L^{k}, L^{k+1} falls below a predefined limit &, wherein the sharpened image L^{k+1} at the time of termination of the iteration represents the desired sharpened image L.

9. The method according to claim 3, wherein the discretized image area Ωₕ is divided into a plurality d=0, . . . , N_{D}−1 of image sections Ω_{d}, and wherein a mathematical model with an image-point-dependent density function is used for the image points of at least one image section, such that a linear system of equations of the form
B^{d}=A^{d}L^{d}[+η^{d}]
is obtained for this image section d.

10. The method according to claim 9, wherein a mathematical model with an image-point-constant density function and constant image trajectory is used for the image points of at least one other image section, such that, for the image points of this image section, a linear system of equations of the form
B^{d}=A^{d}*L^{d}[+η^{d}]
is obtained, with the mathematical convolution operator *, and the sharpened captured image L^{d} of this image section is ascertained by a mathematical deconvolution.

11. The method according to claim 9, wherein the sharpened captured image L is composed of the sharpened captured images L^{d} of the image sections.

12. The method according to claim 1, wherein the image-point-dependent density function ω(p,t) is ascertained by holding the camera stationary and pointing it at a constant object and taking a series of captures {b(p,tᵢ)}ᵢ₌₀^{Ni-1} consisting of Nₜ individual captured images with different start times of the exposure {tᵢ}ᵢ₌₀^{Ni-1} of the constant object, such that, for one image point (p), a plurality of observations {(tᵢ,ωᵢ^{p})}ᵢ₌₀^{Ni-1} are obtained.

13. The method according to claim 12, wherein the plurality of observations ≡(tᵢ,ωᵢ^{p})}ᵢ₌₀^{Ni-1} are stored as an image-point-dependent density function ω(p,t) for this image point (p).

14. The method according to claim 12, wherein the plurality of observations are approximated by a predefined mathematical function with function parameters αₚ by means of a curve approximation, from which the function parameters αₚ are ascertained, and the mathematical function with the ascertained function parameters αₚ for the image point (p) is stored as an image-point-dependent density function ω(p,t).

15. The method according to claim 1, wherein the image-point-dependent density function ω(p,t) is used to map an influence of an opening or closing movement of a mechanical shutter device of the camera on the exposure of different image points (p) of the captured image.
